(19) United States
(12) Patent Application Publication
(10) Pub. No.: US 2015/0124120 A1
(43) Pub. Date: May 7, 2015

(54) MACHINE VISION SYSTEM WITH DEVICE-INDEPENDENT CAMERA INTERFACE

(71) Applicant: Microscan Systems, Inc., Renton, WA (US)

(72) Inventors: Steven J. King, Newfields, NH (US); Serge Limondin, Milford, NH (US)

(21) Appl. No.: 14/156,221

(22) Filed: Jan. 15, 2014

Related U.S. Application Data
(60) Provisional application No. 61/900,241, filed on Nov. 5, 2013.

(51) Int. Cl. H04N 1/21; G06T 11/00; G06T 11/60

(52) U.S. Cl. CPC H04N 1/2137; G06T 11/60; G06T 11/001
USPC 348/231.2

(57) ABSTRACT

Embodiments of a process comprising receiving one or more images in a buffer of a computer communicatively coupled to one or more cameras, retrieving the one or more images from the buffer, and storing the one or more images as one or more memory-mapped image files in a memory-mapped file (MMF) area of a memory that is shared by the computer and the one or more cameras.

### CROSS-REFERENCE TO RELATED APPLICATIONS

This utility application claims priority under 35 U.S.C. §119(e) to U.S. Provisional Application No. 61/900,241, filed 5 Nov. 2013 and still pending. The contents of the priority provisional application are hereby incorporated by reference in their entirety.

### TECHNICAL FIELD

The disclosed embodiments relate generally to machine vision systems and in particular, but not exclusively, to a machine vision system with a device-independent camera interface.

### BACKGROUND

Many modern systems, such as machine vision systems, consist of multiple different components coupled together so that they can communicate and interact with each other. Coupling of the components is usually accomplished using a combination of hardware and software—the hardware provides the tangible physical link between components, while the software controls the hardware and can perform other functions.

These systems offer many advantages, but one disadvantage they have is that different components in the system may operate under different interfaces. Machine vision systems typically consist of at least one camera that captures images and a computer that analyzes them. Each camera is typically communicatively coupled to the computer using a camera interface, of which there are many, such as Analog, CameraLink, Firewire, Gigabit Ethernet, Twain, USB, etc. New camera interfaces are developed all the time, and many imaging devices and sensors do not follow any standard at all but can nonetheless produce useful data for a vision system to analyze. These can be 2D or 3D sensors, flatbed scanners. X-ray imagers, etc. For the sake of this disclosure all of these devices will be referred to as, and are encompassed by, the terms “camera” or “cameras.”

In a typical vision system, transferring an image the camera into the computer requires that custom drivers, drop-in modules, or plugins be written for each type of camera interface, camera vendor, or even family of cameras, to get those cameras to deliver an image to a specific vision system. It takes a lot of development time from the maker of the vision system running on the computer, as well as from the camera manufacturer, to create this camera/vision system interface. This is further complicated by the fact that many camera vendors sometimes do not fully follow published interfaces standards or, if they do follow a published standard, do not keep up with the standard's ongoing revisions. There is a high up-front cost to develop this compatibility between cameras and specific vision systems, as well as high additional costs to maintain the compatibility over time.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram of an embodiment of a machine-vision system.

FIG. 2 is a block diagram of an embodiment of a machine-vision system.

FIG. 3 is a flowchart of an embodiment of a process implemented in a machine-vision camera.

FIG. 4 is a flowchart of an embodiment of a process implemented in a machine-vision system running on a computer coupled to one or more machine-vision cameras.

### DETAILED DESCRIPTION OF THE ILLUSTRATED EMBODIMENTS

Embodiments are described of an apparatus, system and method for a machine vision system with a device-independent camera interface. Specific details are described to provide a thorough understanding of the embodiments, but one skilled in the relevant art will recognize that the invention can be practiced without one or more of the described details, or with other methods, components, materials, etc. In some instances, well-known structures, materials, or operations are not shown or described in detail but are nonetheless encompassed within the scope of the invention.

Reference throughout this specification to “one embodiment” or “an embodiment” means that a feature, structure, or characteristic described in connection with the embodiment is included in at least one described embodiment. Thus, appearances of the phrases “in one embodiment” or “in an embodiment” do not necessarily all refer to the same embodiment. Furthermore, the described features, structures, or characteristics can be combined in any suitable manner in one or more embodiments.

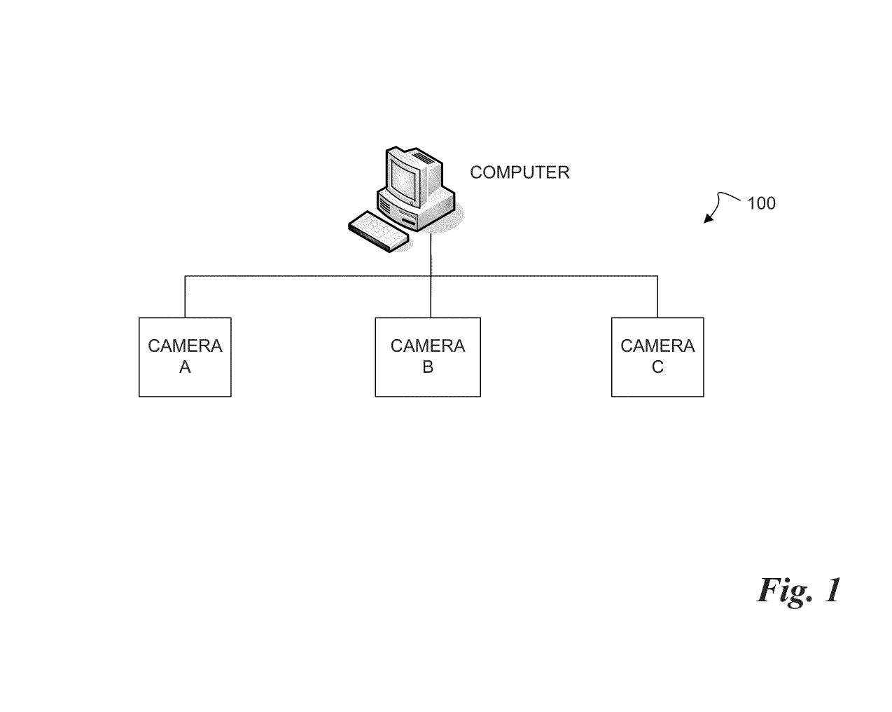

FIG. 1 illustrates an embodiment of a machine vision system 100. As used herein, and as the context requires, the terms “machine vision system” or “vision system” can refer to hardware, as illustrated, or to software running on one or more of the illustrated hardware elements in the system. System 100 includes machine vision cameras A-C coupled to a computer, such as a personal computer in one embodiment. Within machine vision system 100, cameras A-C need not all be the same type of camera and, nor do they need to be coupled by the same kind of communication link. In different embodiments, the communication link between components in system 100 can be hard-wired, wireless, or some combination of the two. If the cameras are different, it can happen that the cameras operate using different software, different command languages and different communication protocols.

The computer runs one or more instances of vision system software, and each instance of the vision system software can run various processes that, among other things, interact with the cameras to acquire images (i.e., image acquisition process) and then analyze the acquired images (i.e. vision analysis or inspection process). Among other things, the disclosed embodiments substantially simplify a vision system by separating the image acquisition process from other vision system processes. The main problem to be solved is to separate the image acquisition drivers from the vision system software while allowing images to be transferred from the camera to the vision system via a simple and fast mechanism that need not change to accommodate the vast array of existing cameras, or new cameras, as next-generation cameras and interface technologies are developed.

Most camera, imager, frame grabber and sensor vendors offer tried-and-proven software with their devices that allow software developers to use the vendor-supplied Software Development Kit (SDK) to completely control the camera and to take pictures. Images, as they are acquired, are stored in RAM as 8, 12 or 24 bit arrays. As a vendor adds new cameras or interfaces, the vendor goes through substantial efforts to test the cameras and ensure that they work robustly within their own SDK. The disclosed embodiments take advantage of the fact that, almost universally, the camera vendor software can store and surface captured images in computer memory. The described embodiment uses a shared memory mechanism called Memory-Mapped Files (MMFs), available in Microsoft Windows and other modern operating systems, to share an area of memory. That special area of memory will contain the image to be shared between the camera and the vision system. This mechanism works transparently across platforms, across processes, and/or within the same process to transfer the image directly to computer memory that the vision system can access.

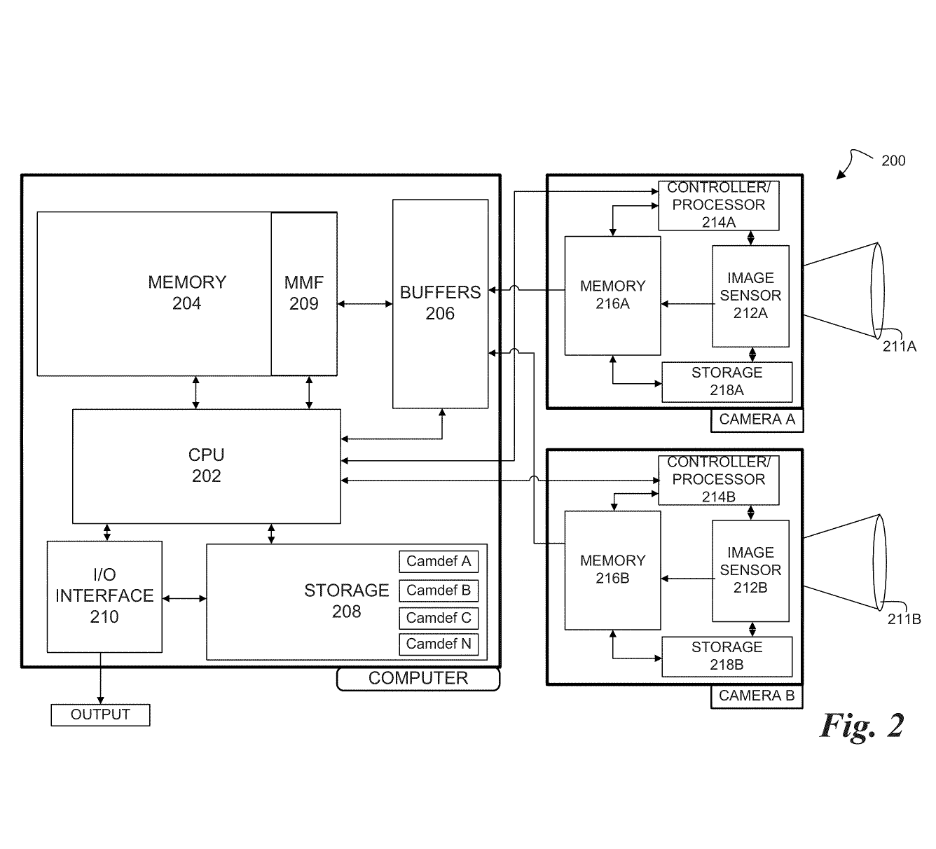

FIG. 2 illustrates, in block diagram form, an embodiment of the hardware associated with a vision system 200. Vision system 200 includes a computer coupled to two cameras: camera A and camera B. Other embodiments of vision system 200 can include less or more cameras than shown—anywhere from one camera to N cameras, where N can be any integer—depending on factors including the processing speed and/or communication capabilities of the computer.

The computer includes a processor (CPU) 202 coupled to a memory 204, buffers 206, storage 208, and input/output (I/O) interface 210. In this application, description of two elements as “communicatively coupled” or “coupled” means the data can be exchanged between the components, unless it is a different meaning is clear from the context in which the term is used. CPU 202 is also coupled to controller/processor 214A in camera A and controller/processor 214B in camera B. CPU 202 can be any kind of processor, from a general application processor to an application specific integrated circuit (ASIC).

Memory 204 is coupled to CPU 202 and buffers 206 so that it can exchange data with both. Buffers 206 are coupled to MMF area 209 of memory 204, to CPU 202, and to memory 216A of camera A and memory 216B of camera B. Memory 204 also includes a memory-mapped file (MMF) area 209 that can also exchange data with buffers 206 and CPU 202. MMF area 209 contains the contents of the image files in virtual memory. This mapping between the file and memory space enables an application, including multiple processes, to modify the file by reading and writing directly to the memory. Using this mechanism, images can be taken using a camera vendor's SDK, and can then then be written to the memory-mapped file. At this point, a simple event can be raised to indicate to the vision system that a new image is in memory and ready to be processed. The vision system acquires the image from memory and then processes it. This scheme is fast and efficient.

Storage 208 is coupled to CPU 202 and I/O interface 210. Storage 208 stores information for the computer, including camera definition (Camdef) files that include configuration information for all cameras coupled to the computer. Information about the camera stored in each Camdef file can include fields for the camera name, the Stride, the Number of Rows, bits per pixel, and pixel type. Pixel type tells the system if this is a monochrome or color image, as well as if it is standard color or formatted Bayer color. In this way, the vision system knows how to interpret the pixel values that are transferred from the image acquisition process. I/O interface 210 is coupled to both CPU 202 and storage 208 and can be used to send and receive data to other devices besides the cameras to which the computer might be connected.

Each of cameras A and B have within them various coupled components, some of which are additionally communicatively coupled to components in the computer. Cameras A and B both include an image sensor 212 optically coupled to corresponding optics 211. Each image sensor 212 (i.e., image sensors 212A and 212B) is also communicatively coupled to a controller/processor 214, a memory 216, and storage 218. In each camera, controller/processor 214 is communicatively coupled to CPU 202, and each camera memory 216 is communicatively coupled, via buffers 206, to MMF memory 209. As a result, the computer and cameras A and B each view MMF memory 209 as their own memory. In other words, MMF memory 209 operates as a shared memory between the computer and the cameras.

An advantage of this arrangement is that it takes advantage of the camera vendor's standard SDK, which takes care of controlling the camera, and which normally writes the image to computer memory. Embodiments of the described arrangement are general enough that camera vendor SDKs for different cameras and camera interfaces can all coexist to share an image captured by a camera and processed with the vision system. The vision system vendor is completely removed from having to control the vast array of camera types. All that is required of the vision system is to wait to be informed that the image is available in the memory-mapped space, at which point it can operate on that image. As previously noted, this arrangement is not limited to cameras, but can be used with many other imaging devices such as flatbed scanners, 3D imagers, X-Ray imagers and non-standard camera types, as long as they produce an array of sensor data that is stored in computer memory.

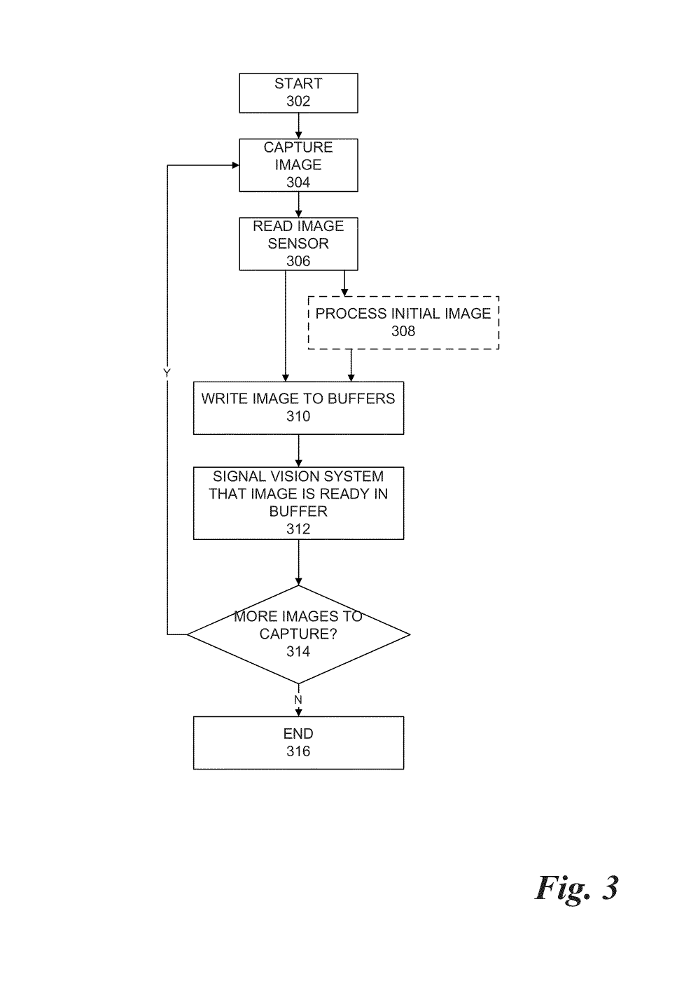

FIG. 3 illustrates an embodiment of a process that can be implemented within each camera in vision system 200; the process is described below with reference to vision system 200. The process starts at block 302. At block 304 image sensor 212, acting together with optics 211, captures or acquires one or more images of one or more objects. Optics 211 focus an image of the object onto image sensor 212, which then captures the image focused on it. In a multi-camera setup such as shown in FIG. 2, different cameras can capture related or unrelated images. In one embodiment of vision system 200, for example, camera A can inspect one assembly line and camera B another, in which case images captured by cameras A and B would be unrelated. In another embodiment, cameras A and B can be used to capture images of different parts of the same object, thereby effectively increasing the field of view of the cameras. In such an embodiment, images captured by cameras A and B would be related.

At block 306 the image data for the images captured by image sensors 212 are read from the image sensors, for example by controller/processors 214. At block 308, which is optional as indicated by its dashed outline, controller/processor 214 can perform initial pre-processing of the image data read from the image sensor to modify, enhance, or improve the optical characteristics of the captured image. Examples of pre-processing in various embodiments include gain adjustment, white balance, color adjustments, and so on.

At block 310, whether reached via block 308 or directly from block 306, the image data is written via camera memories 216 to buffers 206. At block 312, the camera indicates to a vision system running on the computer that images are in buffer 206 and ready for further processing. At block 314, the process checks whether there more images to capture. If there are more images to capture, the process returns to block 304 and goes through the process again. If at block 314 there are no further images to capture, the process ends at block 316.

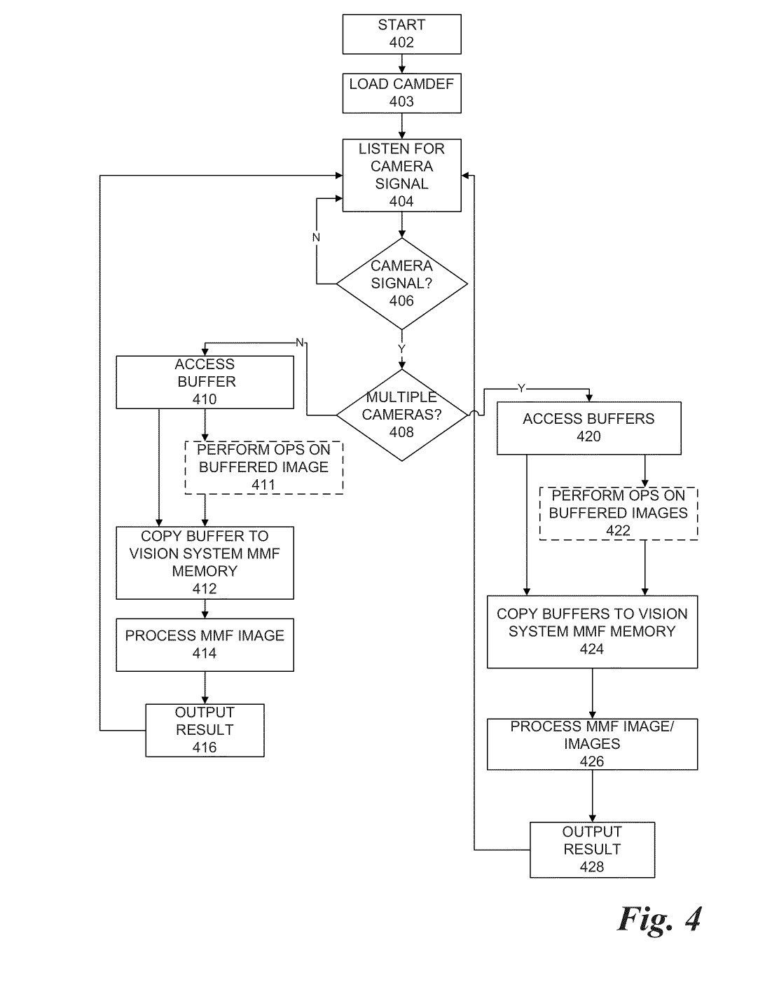

FIG. 4 is a flowchart illustrating an embodiment of a process 400 implemented by one or more instances of a vision system running on the computer in vision system 200, and the process is described below with reference to vision system 200. Generally, each instance of the vision system will run several processes, simultaneously or sequentially, including at least an image acquisition process and an analysis/inspection process. In one embodiment, most of the illustrated process, except blocks 414 and 426, is carried out by an image acquisition process.

The process starts at block 402. At block 403, CPU 202 loads into its onboard memory, or into memory 204, the previously-described Camdef files for each camera coupled to the computer. As described above, the Camdef files contain information about the cameras, so that the relevant processes of the vision system can know the characteristics of the cameras. In this particular implementation, the vision process does not use values from the registry to set up for memory sharing, but instead uses values from Camdef files. In the parameter pages for the vision process, the user can simply select which Camdef file to use, and then select an Acquire Option in the picture-taking step called “Load Image from Memory.” At that point the user can select which named memory-mapped file to use to get the image from for processing. Again, this list of memory-mapped files corresponds to all of the mapped files defined in the registry.

At block 404, the vision system listens for a signal indicating that new image data has been placed in buffers 206 for processing. If at block 406 a signal has not been received from a camera, the process returns to block 404 and continues listening. If at block 406 the camera signal has been received, the process proceeds to block 408.

At block 408, the process checks whether there are multiple cameras coupled to the vision system. If there are not multiple cameras coupled to the computer—that is, if there is only one camera coupled to the computer—the process continues down the left side of the flowchart starting at block 410. At block 410 the vision system accesses buffers 206 and reads the image data from the buffers. At block 411, which is optional as indicated by its dashed outline, the process can pre-process image data from the buffers read from the buffers to adjust various optical characteristics before proceeding to the next block. Adjustments or pre-processing carried out at block 411, if any, can be the same or different than the pre-processing options listed for and/or previously carried out in block 308.

At block 412, whether reached directly from block 410 or through block 411, memory-mapped files are used to transfer images between the image acquisition process and a vision analysis process. Multiple memory maps can be created for each camera connected to the vision system. The image acquisition process in charge of taking the picture creates the memory-mapped file or files for sharing images with the vision system. The memory mapping used to transfer images from the image acquisition process to the vision analysis process is defined in the registry. The mapping for each camera or image is given a unique name, and is given a specific memory buffer size; the unique name associates it to the specific camera or image buffer, and the buffer size corresponds to the size, in terms of pixels, of the sensor or image buffer required to contain that image.

Image data read from the buffers is copied into the MMF memory 209, thus creating a memory-mapped image file of the image data. Each memory-mapped image file is created with the name for that camera's shared image buffer that it obtains from the registry. The image file size is described in term of “Stride” and “Number of Rows.” The Stride corresponds to the number of columns of pixels in the image, and the Number of Rows is the number of rows of pixels in the image. Once the memory-mapped file is created, the image acquisition process then creates an accessor to that memory-mapped file that allows it to safely read and write to it. When an image is acquired and the pixel values are resident in local memory, this process does a Marshal Copy to copy or write the image data from the local array to the memory-mapped file. Once done, a simple event mechanism signals the vision analysis process that an image is available for processing.

At block 414 the analysis/inspection processes of the vision system, using CPU 202, process the MMF image file from MMF area 209, and at block 416 output the results of any vision analysis/inspection carried out on the MMF image files. At this point, the analysis/inspection process also creates an accessor to the memory-mapped file that allows it to safely read from or write to it. It in turn does a Marshal Copy to copy the image data from the memory-mapped file to one of a local array of buffers. Once the image is in this local buffer, the image can be analyzed. The advantage of this final copy is that once the image is copied from the memory-mapped file into local memory, another image can be taken and put into the shared memory buffer while the vision system is busy processing the previous one.

Returning to block 408, if the process discovers that there are multiple cameras, the process continues down the right side of the flowchart starting at block 420. At block 420 the vision system accesses buffers 206 and reads the image data from the buffers.

At block 422, which is optional as indicated by its dashed outline, image data read from the buffers can be pre-processed to adjust various optical characteristics before proceeding to the next block. Adjustments or pre-processing carried out in block 422, if any, can be the same or different than the pre-processing previously carried out in block 308. Other software, such as the Open CV (Computer Vision) library, can be used to modify an image before it is passed to the vision system. For example, in embodiments that capture multiple related images, the multiple images can be stitched together into larger images. Images can be unwarped to zero-out lens or object distortion. Images can be pre-processed with any algorithm that is available as third-party software. All these options can be included in the simpler, smaller application-specific image acquisition process rather than having to be folded into the complex and staid vision system code.

At block 424, whether reached via block 424 or directly from block 420, image data is processed as described above for block 412, and at blocks 426 and 428 the vision system processes the MMF image files from MMF memory 209 and outputs the result as described above for blocks 414 and 416.

This arrangement has many additional benefits. One is image stitching: it is possible to set up a single buffer 206 large enough to contain images from multiple cameras arranged side by side. Images from each camera can be copied into this one buffer by controlling the address of the pointer to arrange the rows and columns from each camera's pixels side by side in memory. A single large image can then be delivered to the vision system for processing. This can be especially useful for line-scan web applications where it is undesirable to lose any rows from the images of the web.

Another benefit on the vision processing side is that multiple vision processes can simultaneously analyze the same image. Typical vision software can spawn multiple analysis/inspection threads, all of which can be directed to run on separate cores of the computer. Every thread can be pointed at the same memory-mapped file, and since the memory-mapped file supports multiple read access, each thread can copy the image and then process different parts of it simultaneously and in parallel. This can make vision processing extremely fast.

Finally, the standard body of code for the vision system, which is often millions of lines long, need not be modified for every added camera. This takes advantage of the fact that the makers of the imaging devices offer robust SDKs to control their cameras. It follows that before images are transferred to the vision system, they can also be manipulated by other third-party software to do things like custom image filtering, image unwarping, etc. Again, this allows the vision system code to remain the same and third-party software all to be used in a secondary solution system image acquisition application.

The above description of illustrated embodiments of the invention, including what is described in the abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description.

The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A process comprising:
receiving one or more images in a buffer of a computer communicatively coupled to one or more cameras;
retrieving the one or more images from the buffer; and
storing the one or more images as one or more memory-mapped image files in a memory-mapped file (MMF) area of a memory that is shared by the computer and the one or more cameras.

2. The process of claim 1, further comprising running an analysis/inspection process on the one or more memory-mapped image files to extract vision data from the memory-mapped image file.

3. The process of claim 1, further comprising generating and/or receiving an indication that the memory-mapped image files are in the MMF area of memory.

4. The process of claim 1, further comprising pre-processing the one or more images retrieved from the buffer before storing them in the MMF memory.

5. The process of claim 4 wherein the one or more images include a plurality of related images and pre-processing includes stitching together the plurality of related images into a single stitched image.

6. The process of claim 5 wherein the single stitched image is stored as a single memory-mapped image file.

7. The process of claim 4 wherein the one or more images are unrelated and pre-processing includes adjusting image characteristics.

8. The process of claim 7 wherein the image characteristics include white balance, color balance, and gain.

9. A non-transitory computer-readable medium having instructions thereon that, when executed by one or more instances of a vision system running on a computer communicatively coupled to one or more cameras, cause the computer to:
receive one or more images in a buffer;
retrieve the one or more images from the buffer; and
store the one or more images as one or more memory-mapped image files in a memory-mapped file (MMF) area of a memory that is shared by the computer and the one or more cameras.

10. The computer-readable medium of claim 9 wherein the medium further includes instructions that cause the computer to run an analysis/inspection process on the one or more memory-mapped image files to extract vision data from the memory-mapped image file.

11. The computer-readable medium of claim 9 wherein the medium further includes instructions that cause the computer to generate and/or receive an indication that the memory-mapped image files are in the MMF area of memory.

12. The computer-readable medium of claim 9 wherein the medium further includes instructions that cause the computer to pre-process the one or more images retrieved from the buffer before storing them in the MMF memory.

13. The computer-readable medium of claim 12 wherein the one or more images include a plurality of related images and pre-processing includes stitching together the plurality of related images into a single stitched image.

14. The computer-readable medium of claim 13 wherein the single stitched image is stored as a single memory-mapped image file.

15. The computer-readable medium of claim 12 wherein the one or more images are unrelated and pre-processing includes adjusting image characteristics.

16. The computer-readable medium of claim 15 wherein the image characteristics include white balance, color balance, and gain.

17. An apparatus comprising:
a memory including a memory-mapped file area therein that is shared by the apparatus and one or more cameras;
a processor communicatively coupled to the memory;
one or more buffers communicatively coupled to the memory and to the processor and configured to be communicatively coupled with the one or more cameras; and
logic to cause the processor, the memory-mapped memory, and the buffers to:
receive one or more images in the one or more buffers,
retrieve the one or more images from the buffer, and
store the one or more images as one or more memory-mapped image files in the memory-mapped file (MMF) area of a memory that is shared by the apparatus and the one or more cameras.

18. The apparatus of claim 17 wherein the logic can further cause the computer to run an analysis/inspection process on the one or more memory-mapped image files to extract vision data from the memory-mapped image file.

19. The apparatus of claim 17 wherein the logic can further cause the computer to generate and/or receive an indication that the memory-mapped image files are in the MMF area of memory.

20. The apparatus of claim 17 wherein the logic can further cause the computer to pre-process the one or more images retrieved from the buffer before storing them in the MMF memory.

21. The apparatus of claim 20 wherein the one or more images include a plurality of related images and pre-processing includes stitching together the plurality of related images into a single stitched image.

22. The apparatus of claim 21 wherein the single stitched image is stored as a single memory-mapped image file.

23. The apparatus of claim 20 wherein the one or more images are unrelated and pre-processing includes adjusting image characteristics.

24. The apparatus of claim 23 wherein the image characteristics include white balance, color balance, and gain.
